(19) United States
(12) Patent Application Publication
(10) Pub. No.: US 2004/0086604 A1
(43) Pub. Date: May 6, 2004

(54) Package having recorded audio pattern

(76) Inventor: Kevin T. Grandey, Rochester, NY (US)

Correspondence Address: JENKENS & GILCHRIST, P.C., 225 WEST WASHINGTON, SUITE 2600, CHICAGO, IL, 60606, US

(21) Appl. No.: 10/690,414

(22) Filed: Oct. 21, 2003

Related U.S. Application Data
(60) Provisional application No. 60/422,762, filed on Oct. 31, 2002.

(51) Int. Cl. C12C 1/027

(52) U.S. Cl. 426/106; 383/64

(57) ABSTRACT

A package includes comprises a plurality of walls defining a volume in which contents can be placed, an opening leading to the volume, a reclosable fastener located at the opening having interlocking members, a slider on the fastener for transitioning the opening between an open state and a closed state, and a profile having a series of projections arranged in a certain configuration, that when engaged by said slider, produce an intelligible, audible message.

### CROSS-REFERENCE TO RELATED APPLICATION

This application claims the benefit of U.S. Provisional Patent Application Serial No. 60/422,762, entitled “Package Having Recorded Audio Pattern,” which was filed on Oct. 31, 2002 and is incorporated herein by reference in its entirety.

### FIELD OF THE INVENTION

The present invention relates generally to packages and, more particularly, to a zipper bag having a slider for playing a recorded audio pattern when the zipper bag is opened or closed.

### BACKGROUND OF THE INVENTION

Film zipper bags with or without sliders are well known in the art. The plastic zippers have profiles and include a pair of male and female fastener elements in the form of reclosable interlocking rib and groove elements. Where a slider is employed, the slider opens and closes the rib and groove elements. The slider facilitates opening and closing the rib and groove elements by providing surfaces that may be easily grasped by the user.

Film zipper bags having sliders that produce a tactile sensation and/or an audible sensation as the slider moves across the profiles are also well known in the art. Zipper bags having sliders manufactured as described in U.S. Pat. No. 5,152,613 have a corrugated structure that when engaged by a slider produce a tactile sensation and/or an audible sensation as the slider moves across the profiles. While U.S. Pat. No. 5,152,613 does not explicitly state that a tactile sensation and/or an audible sensation is produced when moving a slider across the profiles, it is well known in the art that plastic film zipper bags with sliders manufactured as described in U.S. Pat. No. 5,152,613 produce a tactile sensation and/or an audible sensation when advancing the slider to open and close the bag.

Referring now to FIG. 1, a prior art zipper bag 10 as described in U.S. Pat. No. 5,152,613 is shown. The zipper bag 10 includes a zipper at its mouth that includes a pair of flexible plastic strips 11 and 12 extending along the mouth of the bag 10. The flexible plastic strips 11 and 12 include reclosable interlocking male and female profile elements in the form of rib and groove elements on the respective strips. When a slider 13 is attached to the bag 10, the slider will open and close the rib and groove elements. In the manufacture of the thermoplastic film bag 10, the fins of the zipper elements are attached (i.e., heatsealed) to the walls 15 and 16 along the mouth of the bag.

Prior to the improvement in zipper bag technology described in U.S. Pat. No. 5,152,613, an unsightly seal line would appear where the plastic fin of the zipper elements are heatsealed to the walls along the mouth of the bag. U.S. Pat. No. 5,152,613 addresses the unsightly seal line problem by forming zipper teeth T or corrugations along the area where the zipper element fins are heatsealed to the walls. In FIG. 1, the corrugations as formed just below the plastic strips 11 and 12. Further details of how the zipper teeth T or corrugations are formed in the zipper bag 10 are described in U.S. Pat. No. 5,152,613, which is incorporated herein by reference in its entirety.

As discussed above, when a slider is attached to the bag 10 manufactured as described in U.S. Pat. No. 5,152,613, a tactile sensation and/or an audible sensation is produced when moving the slider. As the slider is moved along the plastic strips 11 and 12, the bottom of the slider impacts the zipper teeth T or corrugations. This impact produces an audible sensations that is heard and a tactile sensation that is felt by the person operating the slider on the bag 10. The assignee of U.S. Pat. No. 5,152,613 has sold bags in the marketplace with this feature since 1995.

### SUMMARY OF THE INVENTION

A package comprises a plurality of walls defining a volume in which contents can be placed, an opening leading to the volume, a reclosable fastener located at the opening having interlocking members, a slider on the fastener for transitioning the opening between an open state and a closed state, and a profile having a series of projections arranged in a certain configuration, that when engaged by said slider, produce an intelligible, audible message.

The above summary of the present invention is not intended to represent each embodiment, or every aspect, of the present invention. Additional features and benefits of the present invention are apparent from the detailed description, figures, and claims set forth below.

### BRIEF DESCRIPTIONS OF THE DRAWINGS

FIG. 1 is a zipper bag having a slider according to the prior art.

FIG. 2a is a zipper bag having a slider according to one embodiment of the present invention.

FIG. 2b is an oversized bottom view of a stylus and slider disposed along a portion of a zipper track of a zipper bag according to one embodiment of the present invention.

FIG. 3 is an oversized view of a slider and zipper track closure wherein a recorded pattern is disposed on the zipper track closure according to one embodiment of the present invention.

FIG. 4 is an oversized view of a slider and zipper track closure wherein a recorded pattern is disposed beneath the zipper track closure on the fin area according to another embodiment of the present invention.

FIG. 5a is a prospective view of an extrusion die and rollers for forming a zipper track closure having an intelligible, audible message recorded thereon according to one embodiment of the present invention.

FIG. 5b is a top view of a press plate process for forming a zipper track closure having intelligible, audible message recorded thereon according to an alternative embodiment of the present invention.

FIGS. 6a, 6c, and 6d are exemplary wave forms of an intelligible, audible messages for use with the bag shown in FIG. 2.

FIG. 6b is a side view of a strip having the exemplary wave form of FIG. 6a formed therein that forms a recorded pattern for use with the bag shown in FIG. 2 according to an alternative embodiment of the present invention.

FIGS. 7a, 7b, and 7c are zipper bags have clip-on pieces disposed thereon and that playback an intelligible, audible message according to alternative embodiments of the present invention.

FIGS. 8a and 8b are perspective views of the first and second members of the clip-on pieces shown in FIGS. 7a and 7b.

FIGS. 9a and 9b are perspective views of front and back views of clip-on pieces having animal designs disposed thereon according to alternative embodiments of the present invention.

FIG. 10 is a side view of a container having an intelligible, audible message recorded thereon according to an alternative embodiment of the present invention.

While the invention is susceptible to various modifications and alternative forms, specific embodiments are shown by way of example in the drawings and are described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAIL DESCRIPTION OF THE ILLUSTRATED EMBODIMENTS

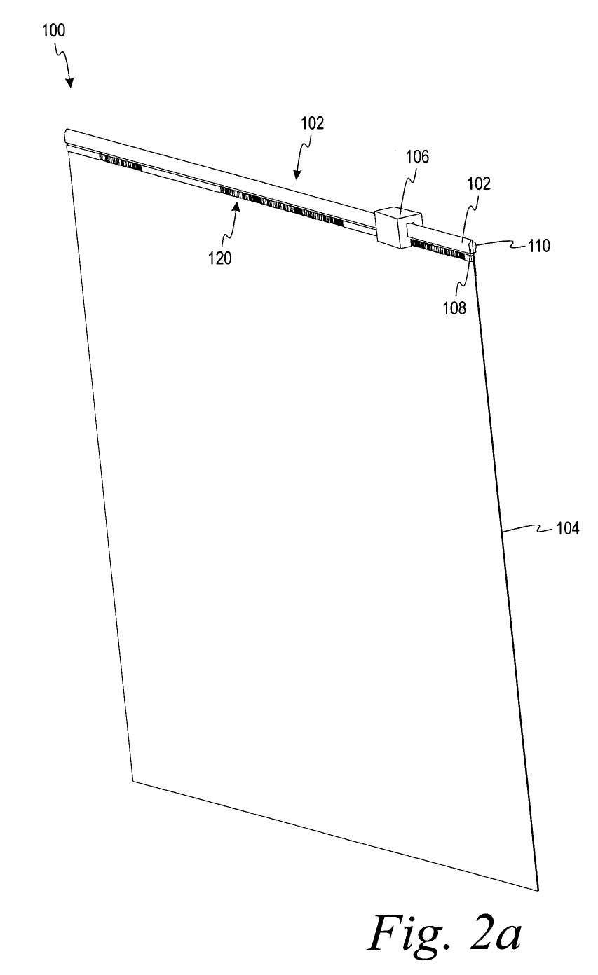

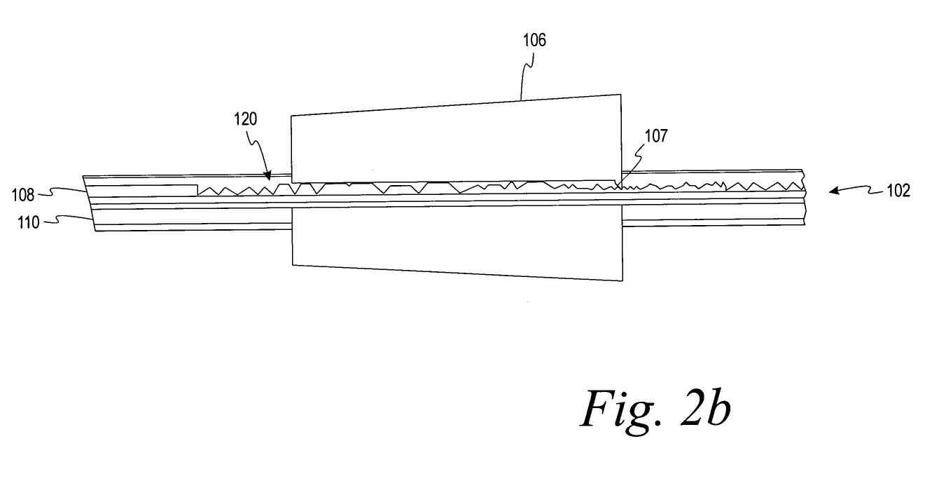

Turning to FIG. 2a, there is shown a slider bag 100 having a prerecorded audio pattern disposed thereon according to one embodiment of the present invention. The slider bag 100 includes a zipper track closure 102, also referred to as a reclosable fastener, and a bag portion 104. The bag portion 104 is constructed by heatsealing sheets of film as is well known in the art. The zipper portion 102 includes fins that are attached to the bag portion 104 at the bag's mouth by techniques well known in the art such as, for example, heatsealing. The bag 100 includes a slider 106 for opening and closing the mouth of the bag 100.

The zipper track 102 includes a pair of flexible plastic strips 108 and 110 extending along the mouth of the bag 104 comprising reclosable interlocking profile elements usually in the form of rib and groove elements on the respective strips. The slider 106 opens and closes the rib and groove elements of the zipper track 102 as the slider 106 is moved along the zipper track 102.

According to the embodiment illustrated in FIG. 2a, the zipper track 102 has a recorded pattern 120 disposed thereon in the form of shaped features along the outside of the plastic strip 108 of the zipper track 102. Generally, the shaped features of the recorded pattern 120 comprise a plurality of peaks and valleys, projections, or slots of varying sizes disposed along or formed in the length of the plastic strip 108. The record pattern 120 is formed such that when a stylus, in contact with the shaped features of the pattern 120, is moved across the recorded pattern 120, the recorded pattern 120 is played back. Put another way, movement of a stylus across the recorded pattern audibly resonates the recorded pattern 120. The recorded pattern 120 may take many forms and can mimic human speech, animal sounds, music, etc. in various alternative embodiments of the present invention. For example, in an application wherein the slider bag 100 is designed for use by children, the recorded pattern 120 produces an intelligible, audible sound and may take the form of a conventional animal sounds such as an “oink” (for a pig), a “bark” (for a dog), a “moo” (for a cow), a “meow” (for a cat), or “quack, quack” (for a duck). In other applications, the recorded pattern can take the form of more complex phrases such as “Lunch for Ricky” or “Meal Time.” In still other embodiments, the recorded pattern is indicative of the brand name of the bag such as, for example, Hefty® or Zoo Pals™. In still other embodiments, the recorded pattern is indicative of the contents of the bag such as, for example, cookies, cheese, fruit, etc. In yet other alternative embodiments, the intelligible, audible sound may take the form of a phase associated with a cartoon character such as, for example, “They're great!” for Tony the Tiger, “Doh!” for Homer Simpson, “What's up doc?” for Bugs Bunny, or “Don't have a cow man!” for Bart Simpson.

Referring also to FIG. 2b, the slider 106 includes a built-in stylus 107 for engaging the recorded pattern 120 as the slider 106 is moved when opening or closing the bag 104 according to one embodiment of the present invention. Thus, as the slider 106 is moved across the zipper track 102, the stylus 107 built into the slider 106 contacts the recorded pattern 120 to audibly resonate the recorded pattern 120. The audible response is amplified by the film side walls that comprise the bag 104.

The frequency of the audible resonation of the recorded pattern 120 is partially dependant on the speed at which the slider 106 is advanced along the recorded pattern 120. The audible resonation will have a high frequency when the slider 106 is rapidly advanced and will have a low frequency when the slider 106 is slowly advanced.

Thus far, the recorded pattern 120 has been discussed as being formed on one of flexible plastic strips 108 of the zipper track 102. However, other alternative embodiments of the present invention are contemplated. For example, the recorded pattern 120 can be disposed on the other of the plastic strips 110. Alternatively, a stereo effect can be produced by providing different, but complimentary, recorded patterns on both flexible plastic strips 108, 110 of the zipper track 102. Alternatively still, alternating recorded patterns are formed on the top side and bottom side of a flexible plastic strip 108, 110 of the zipper track 102. The recorded pattern on the top side is engaged by the stylus when the slider 106 is moved in one direction, and the recorded pattern on the bottom side is engaged by the stylus when the slider 106 is move in the opposite direction.

The recorded pattern 120 is embossed, etched, processed, formed, or otherwise embedded onto the zipper track 102. As shown in the embodiment of FIG. 2, the recorded pattern 120 is disposed on the outside of the zipper track 102. In an alternative embodiment, the recorded pattern 120 is disposed on the inside of the zipper track 102. Alternatively still, the recorded pattern 120 is disposed on the fins of the zipper track 102 or onto a ridge or a bead of plastic that is coextruded onto the fin or film. In yet another alternative embodiment, the recorded pattern 120 is disposed on a length of plastic tape or cord that attached to the fin area of the zipper track 102.

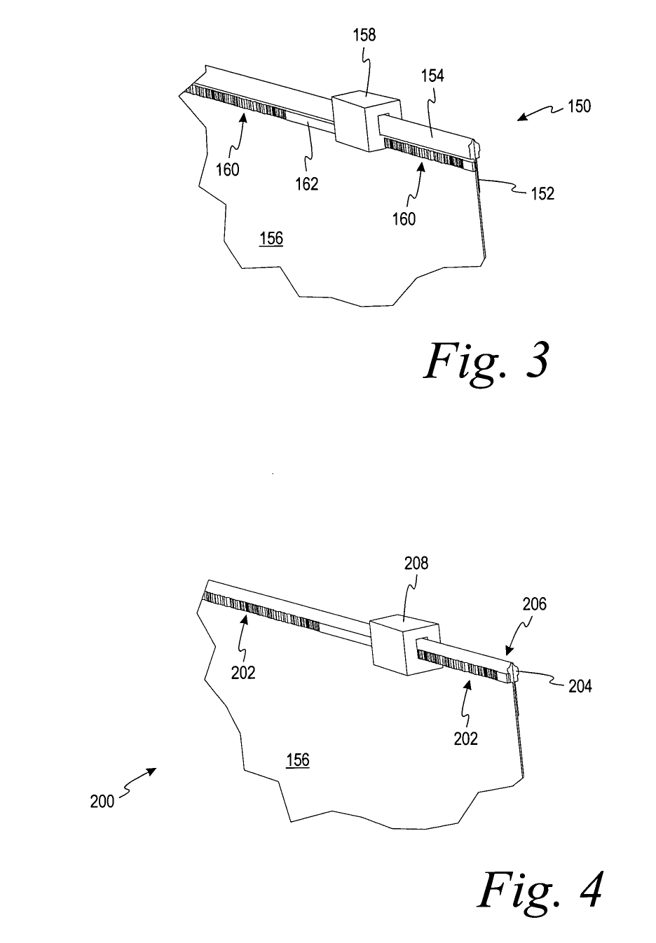

Referring now to FIG. 3, there is shown a portion of a bag 150 having a recorded audio pattern stored thereon according to one embodiment of the present invention. The bag 150 includes a fin area 152 where fins of the zipper track 154 are attached to film 156 that forms the side walls of the bag 150. The bag 150 includes a slider 158 for opening and closing the zipper track 154. In the embodiment illustrated in FIG. 3, the recorded pattern comprises a series of projections 160 that are formed on a plastic strip 162 attached to the fin area 152 of the bag 150. The slider 158 includes a stylus for contacting the projections 160 of the recorded pattern to playback the recorded pattern. As the sound resulting from the stylus contacting the projections 160 is amplified by the film 156 side walls of the bag and/or by the slider 158 in alternative embodiments of the present invention.

Referring now to FIG. 4, there is shown a portion of a slider bag 200 having recorded audio pattern stored thereon according to an alternative embodiment of the present invention. In this embodiment, the projections 202 that form the recorded pattern are formed in one of the profiles 204 that form the zipper track 206. A slider 208 includes a stylus for contacting the projections 202 of the recorded pattern to playback the recorded pattern, which is amplified by the film 156 side walls of the bag and/or by the slider 208.

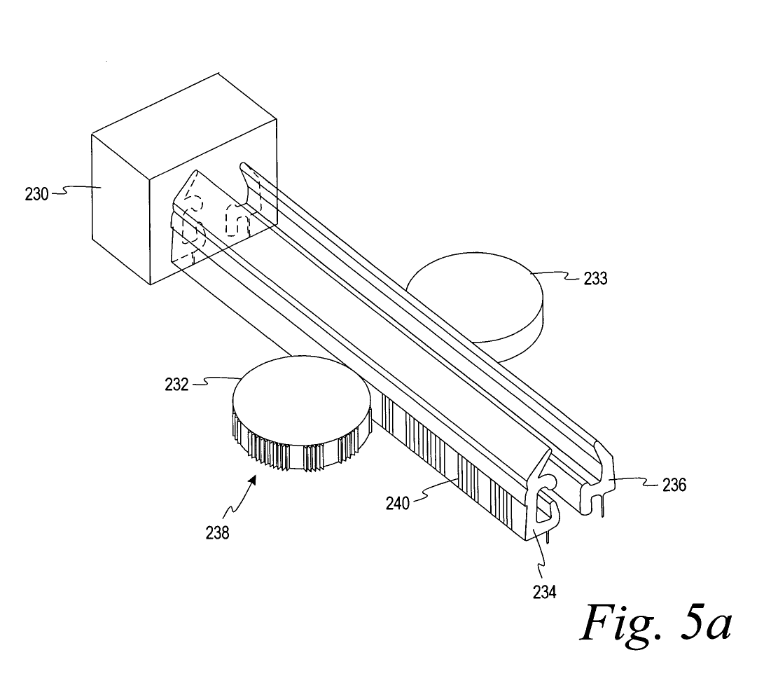

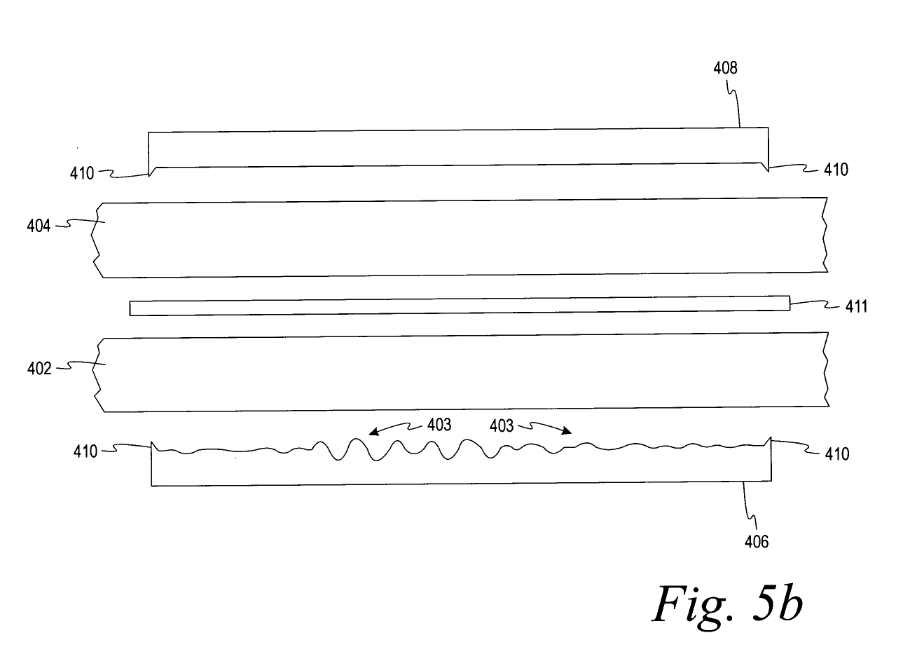

Referring now to FIG. 5a, there is shown an extrusion die 230 and a pair of rollers 232, 233 for manufacturing zipper track closures that includes two flexible plastic strips 234 and 236 having a recorded pattern disposed thereon. In the illustrated embodiment of the present invention, the recorded pattern is formed in one of the flexible plastic strips 234 and the second plastic strip 236 does not have a recorded pattern disposed thereon. The flexible strips 234, 236 are constructed of plastic and are formed by extrusion as is well known in the art according to one embodiment of the present invention.

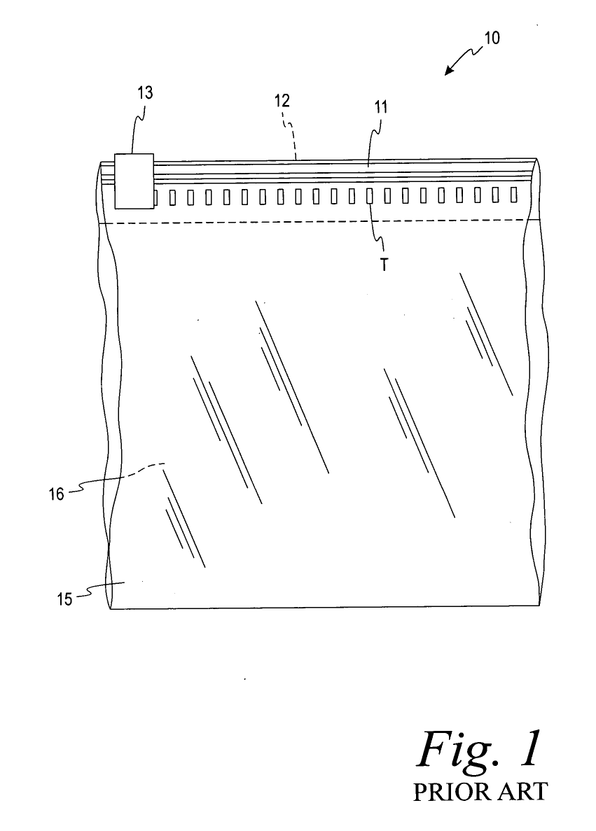

As the flexible strips 234, 236 exit the extrusion die 230, the strips pass through a pair of shaped rollers 232, 233 for forming the recorded message in the first plastic strip 234. The rollers 232, 233 rotate as the flexible strips 234, 236 pass through the rollers. The rollers 232, 233 have a circumference approximately equal to the length of the zipper track for a bag such as the bag 10 illustrated in FIG. 1. Thus, the rollers 232, 233 rotate once per length of zipper track extruded. Alternatively, the circumference of the rollers 232, 233 is approximately equal to the length of the recorded pattern to be disposed along the zipper track, which may or may not be repeated along the length of the zipper track in various alternative embodiments of the present invention.

The first roller 232 has a plurality of projections 238 formed therein that correspond to the recorded message to be formed in the first flexible strip 234. As the first plastic member passes by the first roller 232, the outer surface of the roller 232 having the projections 238 presses against the first plastic strip 234 to form the projections 240 that make up the intelligible, audible message in the plastic strip 234. The rollers 232, 233 are placed in close-enough proximately to the die 230 that the plastic is hot enough to accept the protrusions 240 formed therein by the corresponding protrusions in the first roller 232. Alternatively, the flexible strips 234, 235 are heated before passing through the rollers 232, 233.

According to one embodiment of the present invention, the rollers 232, 233 includes a sharp cutting notch (not shown) for cutting the plastic strips to a predetermined length that is approximately equal to the circumference of the of the rollers 232, 233. In another embodiment of the present invention, a plate (not shown) is disposed between the pair of plastic strips 234, 232 for holding the plastic strips in place as the rollers 232, 233 press against the strips according to one embodiment of the present invention. Alternatively, each plastic strip is pressed between separate pairs of rollers.

Referring now to FIG. 5b, a process for manufacturing the zipper track closure is illustrated according to an alternative embodiment of the present invention. Similar to FIG. 5a, the plastic strips 402, 404 are formed by extrusion as is known in the art. First and second press plates 406, 408 are used to cut the flexible plastic strips to size and the imprint the recorded intelligible, audible message onto at least one of the plastic strips 402, 404. In the illustrated embodiment, a message is formed in the first plastic strip 402 by the first press plate 406, which includes a plurality of projections 403 that correspond to the message to be formed in the zipper track. The press plates 406, 408 include cutting notches 410 to cut the plastic strips 402, 404. In the illustrated embodiment, the press plates 406, 408 press the strips against a stationary center plate 411 disposed between the plastic strips 402, 404.

In operation, a length of zipper track is advanced between the press plates 406, 408. The press plates move towards the pair of flexible strips 406, 408. The projections 403 disposed along the first pressed plate 406 form corresponding projections in the first flexible strip 402 as the plate 406 presses against the strip 404. The cutting notches 420 in the plates cut the strips 402, 404 to a predetermined length.

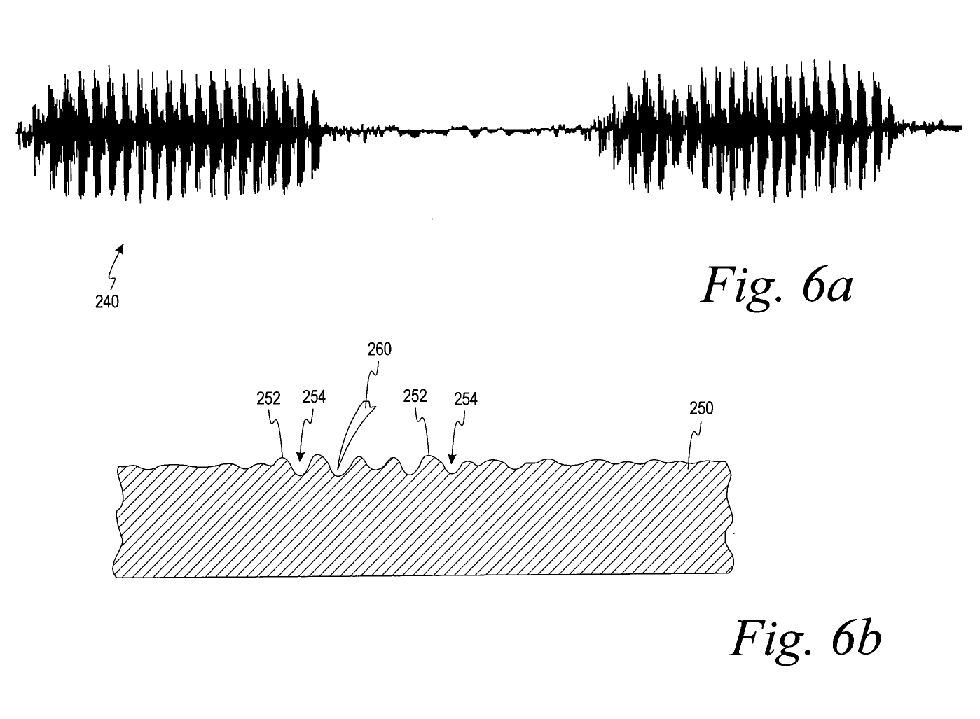

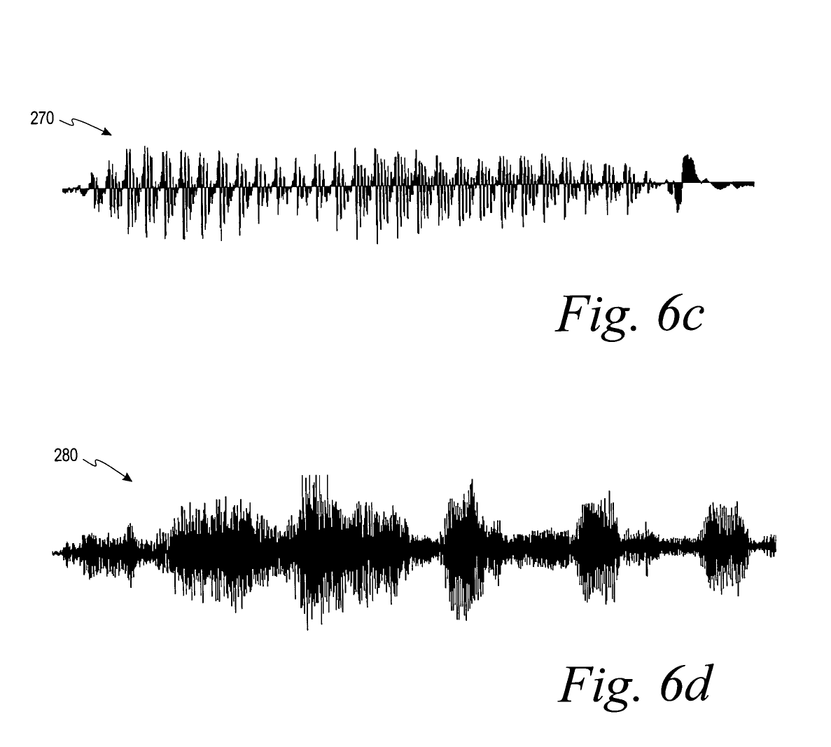

Referring now to FIG. 6a, there is shown an exemplary waveform 240 of a recorded pattern that is played back by the bag as described above. The waveform 240 of FIG. 6a is a waveform resulting from the “quack, quack” sound produced by a duck. FIG. 6b shows a portion of the waveform of FIG. 6a formed into a plastic strip 250. The plastic strip 250 includes a plurality of peaks 252 and valleys 254, also referred to as projections, disposed along the length of the strip 250. As indicated above, the plastic strip 250 is disposed along the fin area of the bag as shown in FIG. 3 or is part of the zipper track of the bag as shown in FIG. 4 according to various alternative embodiments of the present invention. Although not shown, the series of projections may be disposed along the inside of the zipper track or anywhere on the bag where a stylus coupled to the slider can contact the projections in other alternative embodiment of the present invention.

As a stylus 260 coupled to the slider 106 (FIG. 2a) is moved across the series of projections 252, 254 formed in the plastic strip 250 that form the recorded pattern, an intelligible, audible message is produced. The produced message is amplified by the film 156 side walls of the bag and/or the slider. The manner in which the recorded pattern stored via the projections is played-back by the bag is similar to the manner in which a phonograph plays back the recorded pattern disposed on a music records (e.g., an LP), which is described in detail in U.S. Pat. No. 1,020,485 and is incorporated herein by reference in its entirety. The engagement of the stylus vibrates with the recorded phonographic pattern in a manner that is defined by the phonographic pattern. This vibration is transmitted though the various parts of the bag including the slider, the side walls, and the zipper track causing the whole bag to vibrate. The resonation in the side walls causes the air pressure around the bag to fluctuate in accordance with the vibrations defined by the phonographic pattern. These pressure fluctuation are then sensed by a person's eardrum and perceived as sound. The sound produced may be amplified by the slider and also by an optional attachment to the slider, which is described below.

Almost any message can be disposed on the bag for playback. The only limitation is the playback length which is determined by the length of the zipper track along which the slide moves. For example, in an embodiment wherein the slider moves along a zipper track having a length of 12 inches (about 30.5 cm), then the recorded pattern cannot be of a length requiring more than 12 inches (about 30.5 cm) of zipper track for the pattern to be formed in via the above-described projections.

Referring now to FIGS. 6c and 6d, other examples of recorded phonographic patterns that can be coupled to zipper tracks of bags in alternative embodiments of the present invention include “Hello” and a bust of laughter. FIG. 6c illustrated the waveform 270 for “Hello” and FIG. 6e illustrates the waveform 280 for a burst of laughter. The waveforms 270, 280 can be formed on a plastic strip that are coupled to or part of the zipper tracks for zipper bags, similar to that shown in FIGS. 6a and 6b, in alternative embodiments of the present invention.

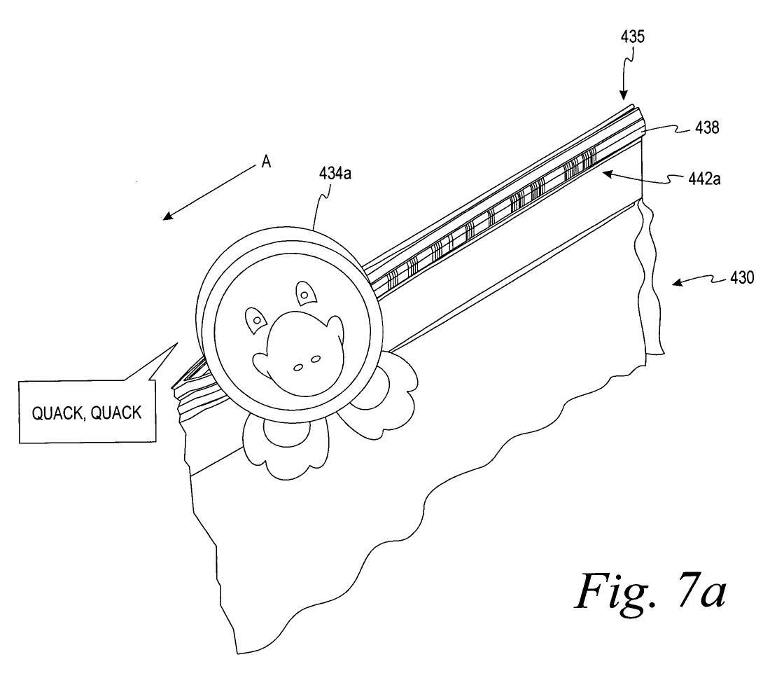

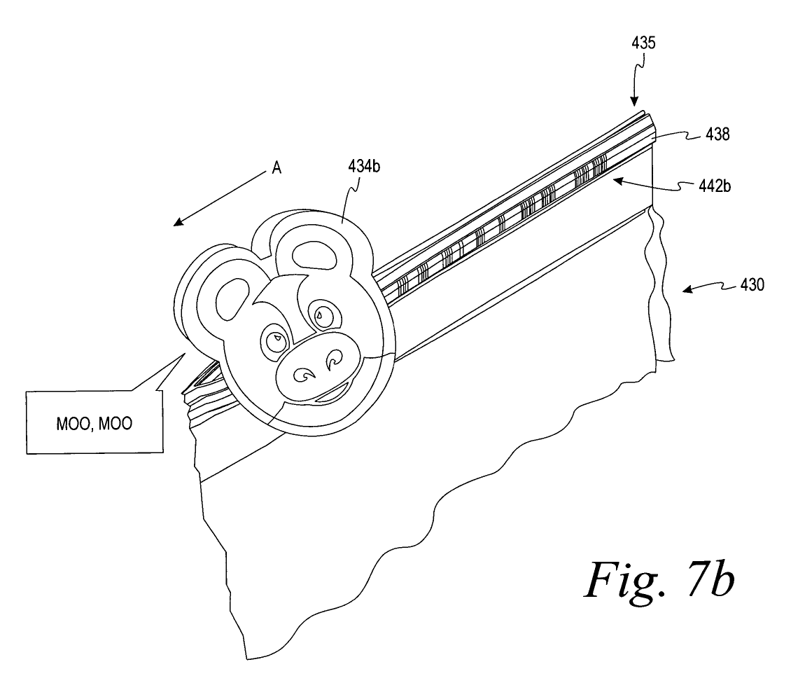

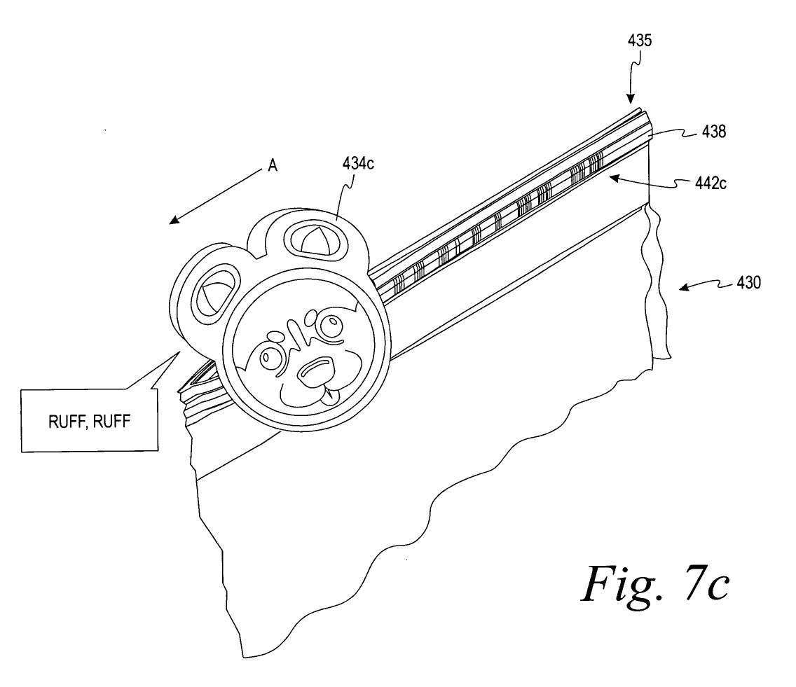

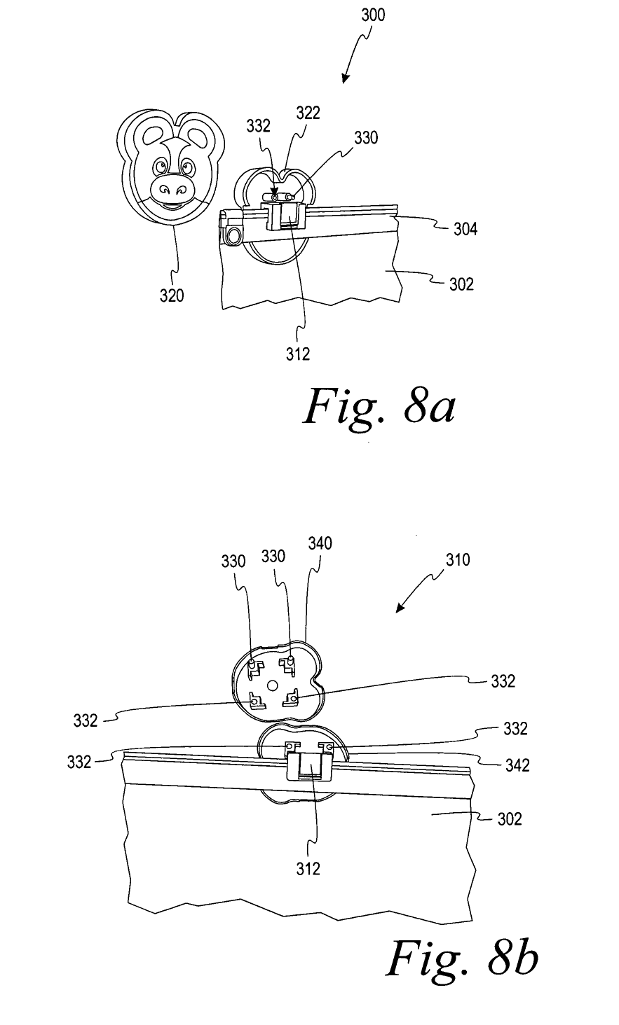

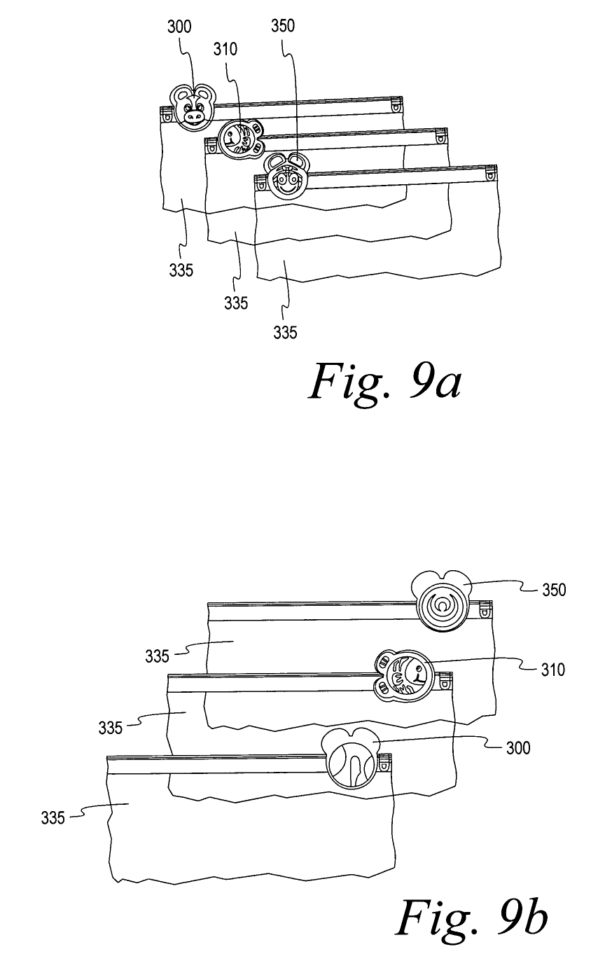

Referring now FIGS. 7a, 7b, and 7c there are shown embodiments of clip-on pieces 434a, 434b, and 434c attached to a slider of zipper bags 430. As discussed in connection with FIGS. 8a-9b, the clip-on pieces 434 depict character designs. For example, in FIG. 7a, the clip-on piece 434a depicts a duck; in FIG. 7a, the clip-on piece 434b depicts a cow; and in FIG. 7c, the clip-on piece 434c depicts a dog. The clip-on piece 434 is attached to the slider (disposed behind the clip-on piece 434; shown in FIGS. 8a,b) of the bag 430. Thus, a user grips the clip-on piece 434 to advance the slider along a zipper track 435 when opening and closing the bag 430.

According to one embodiment of the present invention, the recorded message disposed on the bag 430 can be associated with the character design disposed on the clip-on piece. This intelligible, audible message is formed in one of the profiles 438 that form the zipper track 435 in the form of a series projections 442 along the length of the profiles 428. In FIG. 7a, for example, the clip-on piece 434a has a duck character design disposed thereon and the intelligible, audible message is the “Quack, Quack” sound of a duck. Thus, as the slider is advanced in the direction of arrow A, a “Quack, Quack, sound is produced as the stylus of the sliders is moved across the series of projections 442a. In FIG. 7b, the clip-on piece 434b has a cow character design disposed thereon and the intelligible, audible message embedded in the profile or series of projections 442b is the “Moo” sound of a cow. As the slider is advanced along the zipper track 435 in the direction of arrow A, a “Moo” sound is produced. And in FIG. 7c, the clip-on piece 434c has a dog character design disposed thereon and the intelligible, audible message embedded in the profile or series of projections 442c is the “Ruff, Ruff” sound of a dog.

FIG. 8a illustrates the attachment of the clip-on piece 300 to the slider 312 of bag 302. The clip-on piece 300 comprises a first member 320 and a second member 322. In FIG. 8a, the first member 320 includes a design of a cow's face on its font side. The back side of the second member 322 and the back side of the first member 320 include a plurality of pegs 330 and peg-receiving holes 332 for attaching the clip-on piece to the slider 312. The plurality of pegs 330 and peg-receiving holes 332 are also shown in FIG. 8b. According to one embodiment, the pegs 330 are tapered and have notches formed along the length of the pegs 300 for snapping into the holes 332. In such an embodiment, the holes include a lip or other receiving member disposed in its interior for catching the notches on the pegs as the pegs are snapped into the receiving holes 322. In other alternative embodiments, pegs and holes are disposed on the slider for receiving the corresponding pegs and holes on the clip-on piece.

Turning to FIG. 8b, the backsides of the first and second members 340, 342 forming the clip-on piece 310 having a fish design (FIGS. 9a,b) are shown. The backsides sides of the first and second members 340, 342 that form the clip-on piece 310 include alignment walls 344 according to one embodiment of the present invention. The walls 344 assist in aligning the first and second members 342, 342 around the slider 312. Further, as the user advances the clip-on piece 310, the walls 344 bear against the slider 312 to move the slider 312.

Referring now to FIGS. 9a and b, there are shown a plurality of clip-on members 300, 310, and 350 having a cow design, a fish design, and a bee design, respectively, that are attached to the sliders of bags 355. The first and second members of the clip on member 300, 310, 350 depict different views of the animal design. For example, the first member of the clip-on piece 302 in FIG. 9a depicts the head of the cow and the second member of the clip-on piece 302 shown in FIG. 9b depicts the backside of a cow. The clip-on pieces shown in FIGS. 7a-9b can include designs depicting other characters besides animals in alternative embodiments of the present invention. For example, designs depicting cartoon characters may be disposed on the clip-on pieces. In some embodiments of the present invention, the character design is associated with the recorded patterns on the bag. For example, in one embodiment the design on the clip-on bag depicts Porky Pig and the recorded pattern states “That's all Folks!” Or, in the embodiment where a bee design is depicted on the clip-on piece 310 shown in FIG. 9b, the recorded message may state “buzz” or “buzz, buzz” to mimic the sounds made by a bee. In other alternative embodiments of the present invention, the design disposed on the clip-on piece may depict a trademark associated with the bag such as Hefty® or Zoo Pals™ for example. Alternatively still, the design disposed on the clip-on piece may depict the contents of the bag such as a food item including, for example, a cookie or a block of cheese. Finally, the design disposed on the clip-on piece can correspond to the recorded message. For example, a bag containing Oreo cookies may include a design depicting an Oreo® cookie disposed on the clip-on piece and the recorded message may state “oreos” or “oreo cookies.”

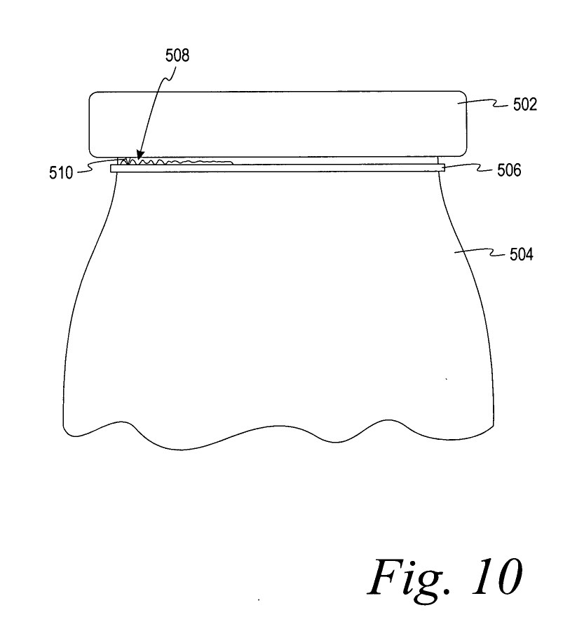

Referring now to FIG. 10, there is shown a lid 502 and a jar 504 that produces an intelligible, audible message when the jar 504 is opened or closed according to an alternative embodiment of the present invention. A plastic strip 506 has a recorded pattern disposed thereon in the form of a plurality of projections 508 similar to that described above. The plastic strip 506 is attached around the jar proximate the threads of the jar 504. A stylus 510 disposed on the lid 502 contacts the plurality of projections 508 that form the recorded message on the plastic strip 506 to playback the recorded, intelligible, audible message as the lid 502 is rotated to open or close the jar 504.

Thus far, the bags having recorded messages disposed thereon have been discussed as being slider-type bags (i.e., bags that are opened and closed using a slider). However, in alternative embodiments of the present invention, the recorded message may be disposed on press-to-close-type bags. Press-to-close-type bags have profiles that include a pair of male and female fastener elements in the form of reclosable interlocking rib and groove elements, but do not include a slider for opening and closing the bag. A user moves the user's fingers along the zipper track to close a press-to-close-type bag. A press-to-close-type bag is opened by pulling male and female fastener elements away from each other. According to various alternative embodiments, the series of projections that form the recorded audio pattern are disposed along the zipper track or along the zipper track's fins (as described above) of the press-to-close-type bag. The series of the projections may be engaged by a user's fingernail or by an object held by a user (e.g., a coin, a piece of plastic, etc.) to produce the intelligible, audible message embedded in the series of projections as the user opens and/or closes the bag.

While the invention is susceptible to various modifications and alternative forms, specific embodiments are shown by way of example in the drawings and herein described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

What is claimed is:

1. A package, comprising:
a plurality of walls defining a volume in which contents can be placed;
an opening leading to said volume;
a reclosable fastener located at the opening having interlocking members;
a slider on said fastener for transitioning said opening between an open state and a closed state; and
a profile having a series of projections arranged in a certain configuration, that when engaged by said slider, produce an intelligible, audible message.

2. The package of claim 1, wherein said intelligible audible message is indicative of a feature of said package.

3. The package of claim 2, wherein said feature is the contents of the package.

4. The package of claim 3, wherein the contents is cookies.

5. The package of claim 3, wherein the contents is cheese.

6. The package of claim 2, wherein said feature is a trademark associated with said package.

7. The package of claim 2, wherein said feature is a character on said package.

8. The package of claim 7, wherein said character is an animal, and said intelligible audible message is an animal sound.

9. The package of claim 8 wherein the animal is a cat the animal sound is a “meow.”

10. The package of claim 8 wherein the animal is a dog and the animal sound is a “bark.”

11. The package of claim 8 wherein the animal is a duck and the animal sound is a “quack.”

12. The package of claim 8 wherein the animal is a frog and the animal sound is a “ribbit.”

13. The package of claim 8 wherein the animal is a cow and the animal sound is a “moo.”

14. The package of claim 7, wherein said character is a cartoon character, and said intelligible audible message are words associated with said cartoon character.

15. The package of claim 1 wherein the profile is separately formed and attached to the reclosable fastener.

16. The package of claim 1 wherein the profile is integrally formed in the reclosable fastener.

17. The package of claim 16 wherein the profile is integrally formed along an outside portion of the reclosable fastener.

18. The package of claim 16 wherein the profile is integrally formed along an inside portion of the reclosable fastener.

19. The package of claim 16 wherein the reclosable fastener includes a male profile element and a female profile element, the profile being integrally formed in one of the male and female profile elements of the reclosable fastener.

20. The package of claim 19 wherein the profile is integrally form in both the male and female profile element.

21. The package of claim 1 wherein the profile is disposed adjacent the reclosable fastener on one of the plurality of walls.

22. The package of claim 21 wherein the profile is formed in a strip of plastic attached to one of the plurality of walls.

23. The package of claim 1 wherein the slider further comprises a stylus for contacting the series of projections of the profile.

24. The package of claim 1 wherein said intelligible, audible message is amplified by said plurality of side walls.

25. The package of claim 1 wherein said intelligible, audible message is amplified by said plurality of side walls.

26. The package of claim 1 wherein said intelligible, audible message is amplified by said slider.

27. The package of claim 1 further including a clip-on piece attachable to the slider.

28. The package of claim 27 wherein said intelligible, audible message is amplified by the clip-on piece.

29. The package of claim 27 wherein said clip-on piece has a character design disposed thereon.

30. The package of claim 29 wherein said character design is an animal design.

31. A package, comprising:
a plurality of walls defining a volume in which contents can be placed;
a reclosable fastener located on said walls and having interlocking members;
a slider coupled to said fastener and moveable between a first position and a second position, said slider having a stylus structure; and
a profile having a series of projections that, in response to said slider moving from said first position to said second position, are sequentially engaged by said stylus structure to produce an intelligible, audible message.

32. The package of claim 31, wherein said intelligible audible message is indicative of a feature of said package.

33. The package of claim 32, wherein said feature is the contents of the package.

34. The package of claim 33, wherein the contents is cookies.

35. The package of claim 33, wherein the contents is cheese.

36. The package of claim 31, wherein the contents is food.

37. The package of claim 32, wherein said feature is a trademark associated with said package.

38. The package of claim 32, wherein said feature is a character on said package.

39. The package of claim 38, wherein said character is an animal, and said intelligible audible message is an animal sound.

40. The package of claim 39 wherein the animal is a cat the animal sound is a “meow.”

41. The package of claim 39 wherein the animal is a dog and the animal sound is a “bark.”

42. The package of claim 39 wherein the animal is a pig and the animal sound is an “oink.”

43. The package of claim 39 wherein the animal is a duck and the animal sound is a “quack.”

44. The package of claim 39 wherein the animal is a frog and the animal sound is a “ribbit.”

45. The package of claim 39 wherein the animal is a cow and the animal sound is a “moo.”

46. The package of claim 38, wherein said character is a cartoon character, and said intelligible audible message are words associated with said cartoon character.

47. The package of claim 31 wherein the profile is separately formed at attached to the reclosable fastener.

48. The package of claim 31 wherein the profile is integrally formed in the reclosable fastener.

49. The package of claim 48 wherein the profile is integrally formed along an outside portion of the reclosable fastener.

50. The package of claim 48 wherein the profile is integrally formed along an inside portion of the reclosable fastener.

51. The package of claim 48 wherein the reclosable fastener includes a male profile element and a female profile element, the profile being integrally formed in one of the male and female profile elements of the reclosable fastener.

52. The package of claim 51 wherein the profile is integrally form in both the male and female profile element.

53. The package of claim 31 wherein the profile is disposed adjacent the reclosable fastener on one of the plurality of walls.

54. The package of claim 53 wherein the profile is formed in a strip of plastic attached to one of the plurality of walls.

55. The package of claim 31 wherein said intelligible, audible message is amplified by said plurality of side walls.

56. A package, comprising:
at least one wall defining an inner volume for holding contents;
an opening to said inner volume;
a member that moves relative to said at least one wall to provide access to said inner volume via said opening; and
a series of projections that, in response to movement of said member, are engaged by a stylus structure to produce an intelligible, audible message.

57. The package of claim 56, wherein said member is a slider.

58. The package of claim 56, wherein said member includes a stylus for engaging said series of projections.

59. The package of claim 56, wherein said member is a rotatable lid.

60. The package of claim 56, wherein said projections are located within said rotatable lid.

61. The package of claim 56, wherein said projections are fixed on said package relative to said at least one wall and said stylus structure is located within said rotatable lid.

62. The package of claim 61, wherein said rotatable lid has an external configuration for enhancing the broadcast of said intelligible audible message.

63. The package of claim 56, wherein said member rotates relative to said at least one wall.

64. A method of using a package, comprising:
moving a member with a first surface relative to a second surface located on said package so as to gain access to an inner volume of said package; and
creating an audible message by engaging a structure on said first surface with a structure on said second surface.

65. The method of 64 wherein said structure on said second surface comprises a series of projections arranged in a certain configuration, that when engaged by said structure on said first surface, produces said audible message.

66. The method of claim 64 wherein creating further comprises creating an intelligible message.

67. The method of claim 64 wherein said member is a slider.

68. The method of claims 67 wherein the first surface of the slider is a surface of a stylus, the stylus being coupled to the slider.

69. A method of providing an audible message to a user of a package, comprising:
while moving a member on said package to gain access to an inner volume of said package, engaging a series of projections with a stylus structure.

70. The method of claim 69 wherein the member is a slider.

71. The method of claim 69 wherein the member is a lid.

72. A package, comprising:
a moveable first member having a first surface;
a stationary second member having a second surface;
a series of projections located on one of said first and second surfaces and a stylus structure located on the other of said first and second surfaces, said series of projections and said stylus structure creating an audible message in response to said first member being moved relative to said second member.

73. The package of claim 72 wherein the moveable first member is a slider for a zipper bag.

74. The package of claim 72 wherein the stationary second structure is one of a pair of profiles forming a zipper track.

75. The package of claim 72 wherein the audible message is an intelligible, audible message.
